(19) United States
(12) Patent Application Publication
(10) Pub. No.: US 2006/0050028 A1
(43) Pub. Date: Mar. 9, 2006

(54) Method and apparatus for an improved micro electro-mechanical display backplane

(76) Inventors: Nicholas F. Pasch, Pacifica, CA (US); Glenn C. Sanders, Mountain View, CA (US)

Correspondence Address: CARPENTER & KULAS, LLP, 1900 EMBARCADERO ROAD, SUITE 109, PALO ALTO, CA, 94303, US

(21) Appl. No.: 11/103,359

(22) Filed: Apr. 11, 2005

Related U.S. Application Data
(60) Provisional application No. 60/561,830, filed on Apr. 13, 2004.
(60) Provisional application No. 60/656,855, filed on Feb. 25, 2005.

(51) Int. Cl. G09G 3/30

(52) U.S. Cl. 345/76

(57) ABSTRACT

A cell suitable for use in a flexible display system is disclosed. In one embodiment, a display system can include a first membrane and second membrane maintained in a spaced apart relationship by a first intermediate layer that can also define cells in a matrix. Each such cell can form a pixel or a portion of a pixel in a particular display application. A third membrane can also be coupled to the first membrane, either directly, or through a second intermediate layer. Such a second intermediate layer can include a plurality of buffer structures that can maintain the spaced apart relationship when the display system is bent. Further, the first membrane can include asymmetrical slots. Also, a plurality of row electrodes may be printed on the first membrane and a plurality of column electrodes may be printed on the second membrane. When appropriate voltages are applied to the row and column electrodes, the first membrane will deflect or bend and make mechanical contact with the second membrane.

### RELATED APPLICATIONS

This application claims the benefit of U.S. Provisional Application No. 60/656,855, filed Feb. 25, 2005 entitled MICRO-ELECTROMECHANICAL SWITCH and U.S. Provisional Application No. 60/561,830, filed Apr. 13, 2004 entitled ENCAPSULATION OF SWITCH ELEMENTS TO SIMPLIFY DESIGN AND ENHANCE UTILITY FOR DISPAY DRIVE CIRCUITRY, which are incorporated herein by reference in its entirety.

### BACKGROUND OF THE INVENTION

1. Field of the Invention

Embodiments of the present invention relate to optical display devices. More particularly, embodiments of the present invention relate to micro electromechanical (MEM) backplane components suitable for enhanced display mechanical flexibility.

2. Description of the Background Art

Optical displays such as liquid crystal displays (“LCDs”), plasma displays and organic light emitting displays (OLEDs), electro-luminescent displays, electronic ink paper displays and other pixel-based displays are used in many products such as computer displays, cellular telephones, flat screen televisions, watches, entertainment devices, microwave ovens and many other electronic devices. Today's optical displays rely on a matrix of thin film transistors and (often) corresponding capacitors, deposited on a glass sheet, to control individual pixels. This transistor and capacitor matrix is often referred to as an “active matrix display backplane” or backplane for short. By applying a voltage to a row electrode and a column electrode, the transistor at the intersection of the row and column controls the pixel while the capacitor holds the charge until the next refresh cycle.

In the conventional active matrix backplane, row and column drivers (generated by electronic circuits that are well known in the art) generate linear voltages while the transistor generates a nonlinear response in the selected pixel or optical cell. A typical optical cell of the type called the liquid crystal cell or the electrophoretic cell is intrinsically slightly nonlinear in its optical response to linear voltages. If this were not the case, the so-called “Passive Matrix” display would not be possible. The transistor in the active matrix backplane exaggerates the nonlinearity of the voltage applied to the row and column crossbar to provide a significant amplification of the row-column select function to cause the optical cell to act more like an ON/OFF switch. By this mechanism of amplification of the select power, the display can create acceptable images without the problems of poor contrast and ghosting seen in passive matrix displays.

A limitation of membrane switch (MEM backplane) designs is that such devices typically require a suitably flat and rigid substrate. For example, a substrate flatness of less than 2 um may be necessary for the smallest implementations of such conventional technology. This limitation can preclude the use of this technology for displays that are fixed in a curved shape and/or pliable.

Further, in some switch array implementations, a limitation in the lifetime of the array may be the contamination of the switching contacts. This contamination may result from environmental gases that leak into the sealed array elements and/or organic chemicals that are exuded from the polymer array substrates. The presence of oxygen, carbon dioxide, water vapor and/or the volatile organic components may be expected to create high resistance pathways on the contact faces of the electrical contacts of the design. Also, metal oxides, hydroxides, and polymerized organic films may accelerate the failure of the switching elements.

What is needed is a MEM backplane component or cell suitable for enhanced backplane flexibility. Further, what is also needed is a selection of materials and processing structure for the MEM backplane cell that substantially reduces the concentration of potentially damaging components.

### SUMMARY OF EMBODIMENTS OF THE INVENTION

Embodiments of the present invention provide a micro electromechanical (MEM) backplane component structure suitable for enhanced display mechanical flexibility. Further, the MEM backplane can be manufactured using materials and/or techniques so as to substantially reduce the concentration of potentially damaging components. A matrix of MEM switches can be incorporated into the backplane structure of an optical display.

In one embodiment, a display system can include a first membrane and second membrane maintained in a spaced apart relationship by a first intermediate layer that can also define cells in a matrix arrangement. Each such cell can form a pixel or a portion of a pixel in a particular display application. A third membrane can also be coupled to the first membrane, either directly, or through a second intermediate layer. Such a second intermediate layer can include a plurality of buffer structures that can maintain the spaced apart relationship when the display system is bent. Further, the first membrane can include asymmetrical slots. Also, a plurality of row electrodes may be printed on the first membrane and a plurality of column electrodes may be printed on the second membrane. When appropriate voltages are applied to the row and column electrodes, the first membrane will deflect or bend and make mechanical contact with the second membrane.

When the mechanical connection is made, electrical components are provided on the membranes such that an electrical circuit is formed to energize a display medium disposed on the side of the plastic membrane that is facing away from the first or flexible membrane. When the display medium is energized, it defines an “on” state for that pixel or portion of a pixel. The display medium may be an electrophoretic display medium or other type, such as OLED or liquid crystal. For OLED displays, voltage may be applied to the display medium through a via connection formed in the second (e.g., plastic) membrane. When the electrical circuit is broken the electrostatic force holding the two membranes in mechanical contact is lost and the two membranes will separate or return to the “off” state, where the pixel is in the dark or non-emitting state, for example.

In another embodiment, a micro electromechanical (MEM) switch can include: (i) a first membrane and second membrane maintained in a first spaced apart relationship by a first intermediate layer, where the first membrane is deflected toward the second membrane in response to a bias; and (ii) a third membrane maintained in a second spaced apart relationship from the first membrane by a second intermediate layer, where the second intermediate layer can maintain the first spaced apart relationship when the MEM switch is bent.

In another embodiment, a method of making a MEM switch can include the steps of: (i) depositing a first intermediate layer on a first membrane; (ii) attaching a second membrane to the first intermediate layer; (iii) adding a gettering material to a third membrane; and (iv) attaching the third membrane to the second membrane. One or more of the above steps can include the use of roll-to-roll manufacturing or printing type technology, for example.

These embodiments together with other various provisions and features are attained by devices, assemblies, systems and methods of embodiments of the present invention, various embodiments thereof being shown with reference to the accompanying drawings, by way of example only and not by way of any limitation.

### BRIEF DESCRIPTION OF THE DRAWINGS

FIG. 1 is a sectional side view of an exemplary cell of an exemplary micro electromechanical switch in an off and flat state in accordance with an embodiment of the present invention.

FIG. 2 is a sectional side view of an exemplary cell of an exemplary micro electromechanical switch in an on and flat state in accordance with an embodiment of the present invention.

FIG. 3 is a sectional side view of an exemplary cell of an exemplary micro electromechanical switch in an off and bent state in accordance with an embodiment of the present invention.

FIG. 4 is a sectional side view of an exemplary cell of an exemplary micro electromechanical switch in an on and bent state in accordance with an embodiment of the present invention.

FIG. 5 is a sectional side view of an exemplary cell of an exemplary micro electromechanical switch in an off and flat state in accordance with an alternate embodiment of the present invention.

FIG. 6 is a sectional side view of an exemplary cell of an exemplary micro electromechanical switch in an on and flat state in accordance with an alternate embodiment of the present invention.

FIG. 7 is a sectional side view of an exemplary cell of an exemplary micro electromechanical switch in an off and bent state in accordance with an alternate embodiment of the present invention.

FIG. 8 is a sectional side view of an exemplary cell of an exemplary micro electromechanical switch in an on and bent state in accordance with an alternate embodiment of the present invention.

FIG. 9 is a plan view of a flexible membrane of a cell of the micro electro-mechanical switches in accordance with an embodiment of the present invention.

FIG. 10 is a sectional side view of an exemplary cell having the flexible membrane of FIG. 9 in an exemplary micro electromechanical switch in an on state in accordance with an embodiment of the present invention.

FIG. 11 is a flow diagram of a method of making an exemplary micro electro-mechanical switch in accordance with embodiments of the present invention.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. However, embodiments of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

One embodiment includes an array of mechanical switches controlled by row/column electrodes that are accessible by drivers similar in operation to conventional displays. The array is used to create nonlinear voltage or current switching responses that are applied or impressed on the optical cells of the display to generate an image. Note that other types of display technologies or electrical design or fabrication techniques can be used in conjunction with those specific technologies, designs or techniques described herein. For example, features of the MEM switching approach can be used with any type of actuator, switch, chemical or physical device or property, etc., to cause an effect suitable for imaging in an optical display. In general, any type of suitable driver or drive signal can be used.

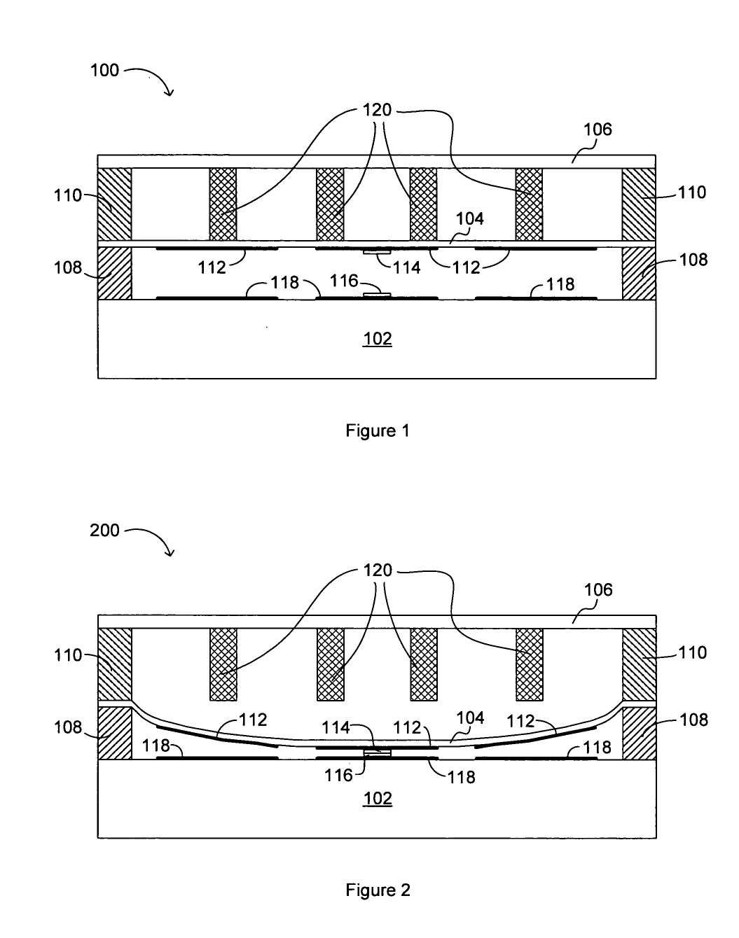

Referring now to FIG. 1, a sectional side view of an exemplary cell of an exemplary micro electromechanical switch in an “off” and flat state in accordance with an embodiment of the present invention is shown and indicated by the general reference character 100. In a scalable optical display, millions of such cells may be arrayed in a matrix or other pattern to effectuate an intended display image. When used in a display embodiment, each cell 100 may control an individual pixel or a portion of a pixel, for example. By creating an electrostatic force, opposing foils in each cell are selectively controlled to form an electrical contact between two conductors. When the conductors come into contact, a circuit is completed that delivers the necessary power to the pixel. The matrix of cells is ideally suited to function as the backplane for a variety of display types such as liquid crystal displays (“LCD”), plasma displays, organic light emitting displays (OLED), electro-luminescent displays, electronic ink paper displays or other pixel-based displays. In other applications, such as by way of example, cell 100 securely stores digital information with minimal power requirements by performing the function of a silicon transistor that stores information in a static random access memory (RAM). In still other applications, cell 100 functions as a micro electromechanical (MEM) switch that is adaptable to a variety of applications.

In one embodiment, cell 100 is constructed with at least three membranes. A more rigid or substantially non-pliable membrane 102 may be used as a reference plane for the cell. However, as will be discussed in more detail below, cells according to embodiments may be bent to accommodate flexible display systems. Accordingly, “non-pliable” with reference to membrane 102 may be relative to other membranes included in cell 100. An electrode, such as a column electrode 118, is printed or otherwise formed on membrane 102. Electrode 118 may include a pattern of copper, such as three tracks per cell, with the center track supporting contact 116, for example. A coating of chromium can be applied along a surface of contact 116 to minimize “stiction” and oxidation of the contact. To prevent electrical shorts, a thin insulator may also be applied over electrode 118 and portions of contact 116.

A substantially flexible membrane 104 may be maintained in a parallel spaced apart relationship with respect to membrane 102 by a spacer layer 108. Membrane 104 may include a second electrode 112 either printed or deposited on membrane 104. Electrode 112 may be a pattern of a metal (e.g., aluminum), such as three tracks per cell, with the center track supporting contact 114, for example. It is preferred that the metal have a modulus of elasticity that is similar to the modulus of elasticity of the flexible membrane. Contact 114 may be positioned closely proximate to the center of cell 100 and in alignment with contact 116 so that a circuit may be formed when membrane 104 is deflected, or brought into proximity with membrane 102. Contact 114 also may have a layer of chromium applied to its surface.

Spacer layer 108 may essentially be a frame that extends around cell 100 to support flexible membrane 104 in a spaced apart relationship with respect to membrane 102. Conceptually, spacer layer 108 may form a perimeter and define a boundary of cell 100. Spacer layer 108 may create a region in the interior region of cell 100 into which membrane 104 can intrude when the proper electrical controls are applied to electrodes 112 and 118.

Spacer layer 108 may be a patterned plastic foil that is ultrasonically or chemically bonded or heat welded to membranes 102 and 104. However, it is preferred that spacer layer 108 be defined by a printing process that accurately places ink to define the perimeter of cell 100. Alternatively, spacer layer 108 can be defined by coating membrane 102 or membrane 104 with a photoresist material that is coated on or applied to the membrane, dried or cured and patterned using conventional photolithography techniques. The thickness of spacer layer 108 is preferably in the range of 0.5 μm to about 50 μm, but can be usefully implemented outside this range as the display size and resolution mandates. It is desirable that spacer layer 108 be as high or tall as possible to compensate for surface variations in the membranes. In most applications, spacer layer will range from about 4 μm to about 25 μm. In general, any suitable fabrication techniques can be employed to create the structures described herein.

Spacer layer 108 may sufficiently elastic to allow some torquing but is sufficiently stiff to support membrane 104. It is to be noted that as used herein, the terms “non-pliable” and “flexible” are used to denote a degree of either rigidity or flexibility so long as the membranes are rigid enough to give the cell the necessary structural integrity and operation.

Typically, selecting a slightly thicker membrane for membrane 102 or a higher elastic modulus than the elastic modulus for membrane 104 achieves sufficient structural stiffness. However, membrane 102 and spacer layer 108, in one embodiment, may be sufficiently thin and flexible such that the switch matrix could be twisted, bent or wrapped around an object such as a tree or a pole. It should be apparent to one skilled in the art that different materials and material properties (e.g., dimensions, elastic modulus, etc.) may be used and still achieve the desired functionality.

Membranes 102 and 104 are both preferably selected from material that is both flexible and has a long flexural lifetime. Preferred materials that can meet these requirements include polymers and more specifically, polyimides, polyethylene terephthalate (PET), polyethylene naphthalate (PEN) and many other polymer, polymer alloys or elastic materials. Depending on the type of material selected for membrane 102 and membrane 104, the flexibility will be inversely proportional to the thickness of the membrane. Thus, the thickness of a relatively non-pliable membrane will be determined by the pliability requirement of a particular application, the type of material selected for the membrane and the electrostatic sensitivity of the electrophoretic material, with less sensitive materials demanding a thinner membrane. Useful range of thickness of non-pliable membrane extends from about 10 μm to about 100 μm; however, thicknesses outside this range are contemplated. The relatively flexible membrane may be selected from the same preferred material as the relatively non-pliable membrane or may be of a different material. However, the flexible membrane will normally be thinner than non-pliable membrane as it is intended to extend from an initial spaced-apart position disposed parallel to the relatively non-pliable membrane to a position where the two membranes are in mechanical contact with each other. Thus, it will be further appreciated that the selected thickness and pliability of membranes 102 and 104 will vary as a function of the material selected and the application.

Because each membrane carries opposing contacts coupled to drive electronics, a circuit is completed whenever flexible membrane 104 is moved sufficiently close to relatively non-pliable membrane 102. When membrane 104 deflects toward membrane 102, contact 114 electrically couples to contact 116 and forms a circuit to provide power to the display medium. In one embodiment, such a display medium may be an electrophoretic material (not shown, but may be on the bottom of membrane 102, for example) that reflects light when biased with an appropriate voltage. When the membrane 104 is allowed to return to its spaced apart relationship with respect to membrane 102, the circuit is broken and the electrophoretic material may no longer reflect light from the associated pixel. More specifically, without the attractive electrostatic force between the electrodes, the mechanical force caused by the deflection of membrane 104 can cause it to spring away and physically separate from membrane 102. The physical separation may interrupt the flow of power to the electrophoretic material. Thus, cell 100 can function in a substantially identical manner to that of the silicon thin film transistors (TFT) active matrix backplane except that it relies on mechanical forces rather than on the physics of a semiconductor device. However, the power available to select the switch cell is independent of the power that drives the electrophoretic material or other appropriate display material can provide advantages to an optical display designer that are not readily available if a conventional semiconductor backplane is used.

A MEMS type display backplane according to embodiments can substantially include five layers: membrane 102, first intermediate layer 108, membrane 104, second intermediate layer 110, and membrane 106. Intermediate layer 110 can also include a series of “column” or “buffer” structures 120. In some embodiments, perhaps several buffer structures per pixel area can be included. These buffer structures may be attached to membrane 106, for example. Buffer structures 120 can be fabricated at substantially the same time and/or with the same or similar technology as the other elements of intermediate layer 110. Accordingly, such buffer structures 120 may not constitute added complexity in the manufacturing process. During normal operation of the display system, these buffer structures 120 may or may not contact membrane 104. When the display is bent back or fixedly curved, the buffers can contact some portions of membrane 104 in order to substantially maintain a spaced apart relationship and/or substantially fixed distance between membrane 104 and membrane 102 in the “off” state.

The mechanism for switching cell 100 comes about by creating an electrostatic force to attract flexible membrane 104 to non-pliable membrane 102. With electrostatic forces present, that is, when electrodes 112 and 118 are biased with a voltage differential that is sufficient to create the electrostatic force, membrane 104 will be deflected or pulled toward membrane 102 until the two membranes are in a mechanically engaged relationship. Referring now to FIG. 2, a sectional side view of an exemplary cell of an exemplary micro electromechanical switch in an “on” and flat state in accordance with an embodiment of the present invention is shown and indicated by the general reference character 200. FIG. 2 schematically illustrates the deflection of flexible membrane 104 that occurs when the proper voltages are applied to electrodes 112 and 118, as discussed above. As illustrated, membrane 104 may be mechanically deflected until contact 114 engages contact 116. When the appropriate electrode voltage is removed, the mechanical energy stored in flexible membrane 104 causes the electrodes to separate when contact 114 breaks mechanical contact with contact pad 116.

According to embodiments, when the display is bent backward, buffer structures 120 can act to substantially maintain the spacing between membrane 104 and membrane 102 so that the electrical properties of the display backplane may not be significantly altered as the display is being deformed. In one embodiment, all associated external connections to the array can remain unchanged from an implementation with no buffer structures 120. Further, other normal function of the MEM backplane is expected from a design using buffer structures 120 according to embodiments. Such an implementation, however, may need minor modification to accommodate a reduction in gas buffer volume because of the presence of buffer structures 120.

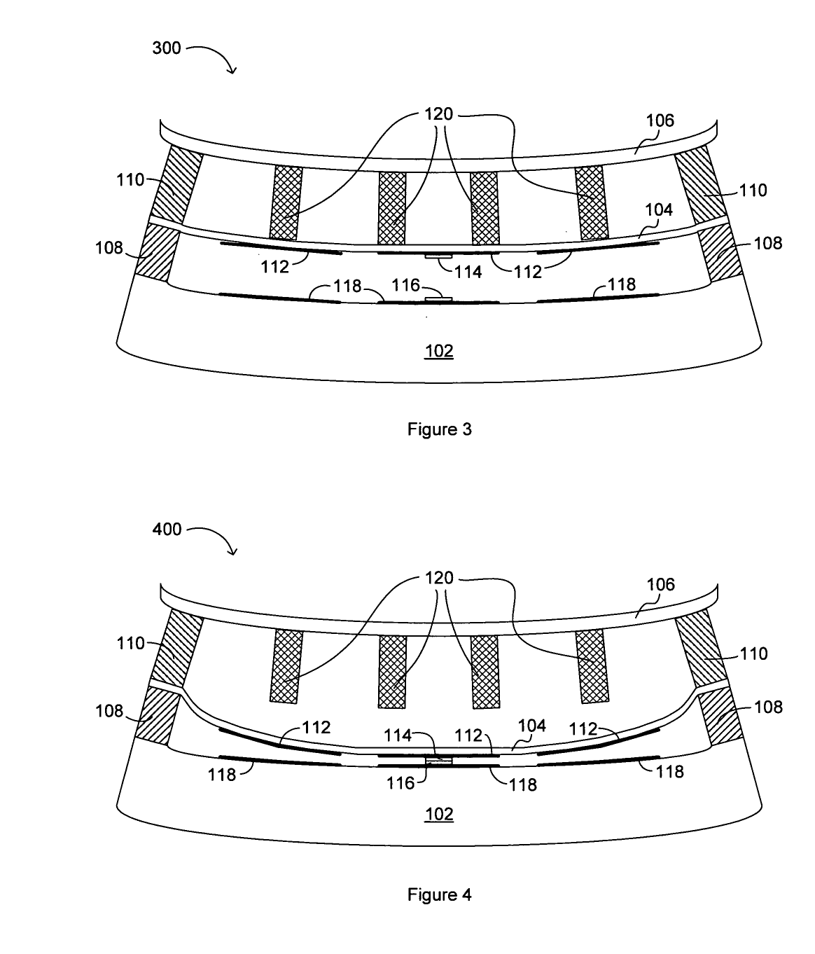

Referring now to FIG. 3, a sectional side view of an exemplary cell of an exemplary micro electromechanical switch in an “off” and bent state in accordance with an embodiment of the present invention is shown and indicated by the general reference character 300. FIG. 3 corresponds to FIG. 1, but with the display bent backwards. In FIG. 3, buffer structures 120 may make contact with membrane 104 in order to substantially maintain the spaced apart relationship between membrane 104 and membrane 102, as discussed above.

Referring now to FIG. 4, a sectional side view of an exemplary cell of an exemplary micro electromechanical switch in an “on” and bent state in accordance with an embodiment of the present invention is shown and indicated by the general reference character 400. As discussed above, part of the normal operation of the cell is the deflection of membrane 104 toward membrane 102 in response to appropriate voltages applied to electrodes 112 and 118. Once such applied voltages are removed, membrane 104 can return to the state as shown above in FIG. 3.

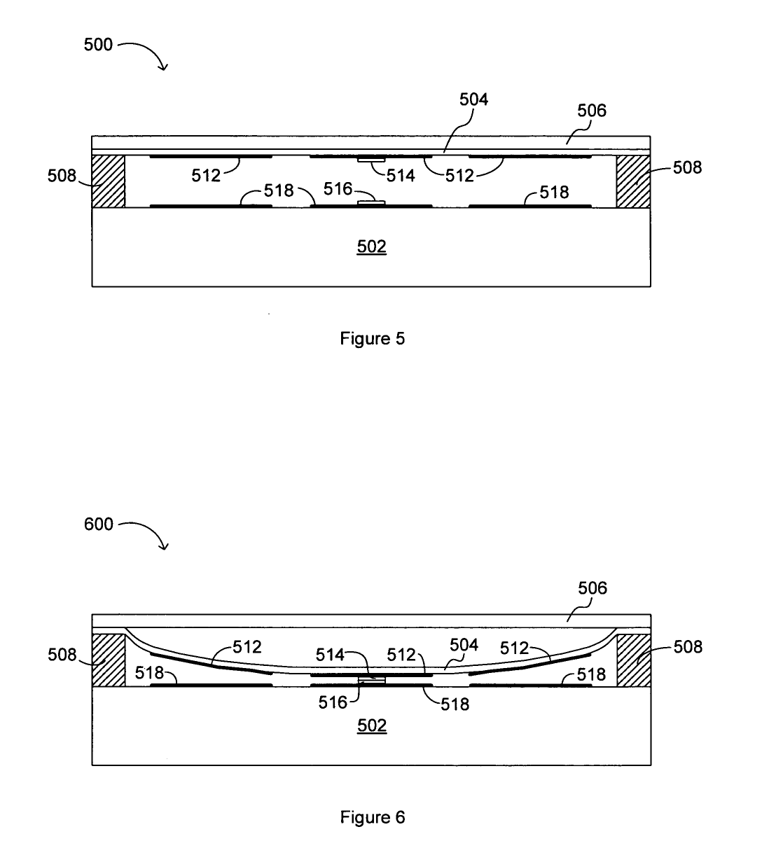

Another aspect of embodiments of the present invention is the possible elimination of buffer structure 120 so that membrane 106 is substantially placed in direct contact with membrane 104 to provide similar stabilization as buffer structures 120. Referring now to FIG. 5, a sectional side view of an exemplary cell of an exemplary micro electromechanical switch in an “off” and flat state in accordance with an alternate embodiment of the present invention is shown and indicated by the general reference character 500. In FIG. 5, relatively rigid membrane 502 may have a display material (not shown) on the bottom. On the top of membrane 502 may be electrodes 518 and intermediate layer 508. Intermediate layer 508 may act to substantially maintain a spaced apart relationship between relatively rigid membrane 502 and relatively flexible membrane 504 and to define a cell boundary. Electrodes 512 can be on membrane 504 and membrane 506 can be on membrane 504. Contact 516 can be on center electrode 518 so as to substantially align with contact 514 on center electrode 512.

Referring now to FIG. 6, a sectional side view of an exemplary cell of an exemplary micro electromechanical switch in an “on” and flat state in accordance with an alternate embodiment of the present invention is shown and indicated by the general reference character 600. As shown, membrane 506 can remain substantially rigid and may maintain contact with membrane 504 near the cell boundary (e.g., near intermediate layer 508) while membrane 504 is deflected so as to contact with membrane 502 via contacts 514 and 516. Accordingly, membrane 506 may be fixedly attached to membrane 504 and/or intermediate layer 508 near the cell boundary, but may allow membrane 504 to deflect toward membrane 502 in an “on” state. In this fashion, membrane 506 may provide a top side support for membrane 504 to accommodate a possible bending of the display system.

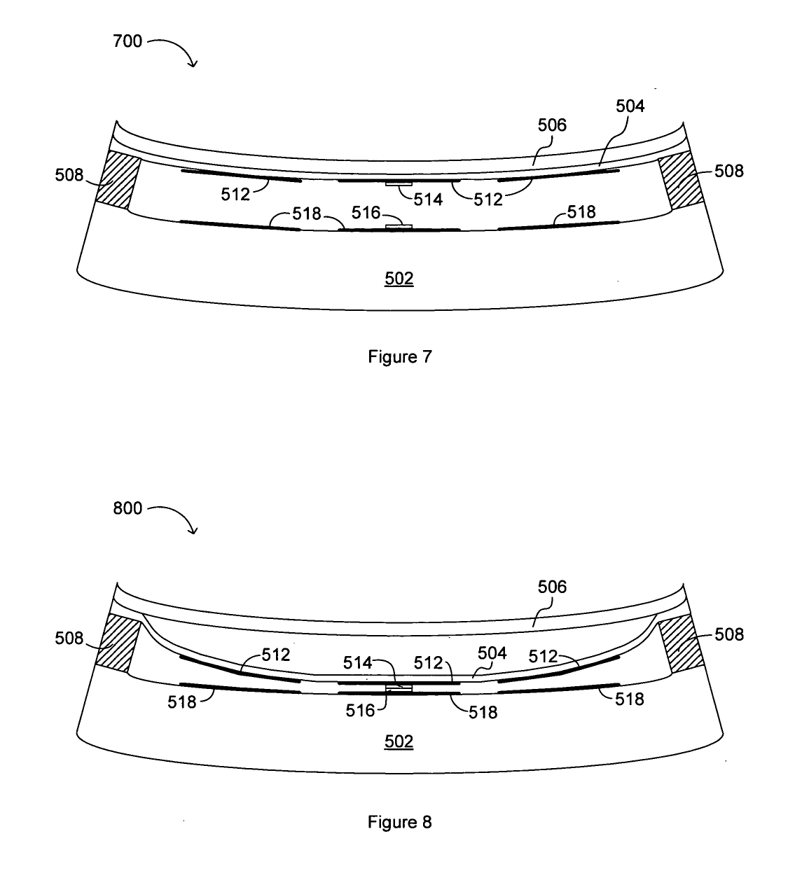

Referring now to FIG. 7, a sectional side view of an exemplary cell of an exemplary micro electromechanical switch in an “off” and bent state in accordance with an alternate embodiment of the present invention is shown and indicated by the general reference character 700. As described above with reference to FIG. 3, the display system can be fixedly curved or bent backwards. According to embodiments, membrane 506 may support membrane 504 so as to substantially maintain a spaced apart relationship between membrane 504 and membrane 502. Referring now to FIG. 8, a sectional side view of an exemplary cell of an exemplary micro electromechanical switch in an “on” and bent state in accordance with an alternate embodiment of the present invention is shown and indicated by the general reference character 800. In FIG. 8, membrane 506 is shown fixedly secured to membrane 504 and/or intermediate layer 508 near the cell boundary. In this fashion, normal cell operation, including the deflection of membrane 504 toward membrane 502 (e.g., an “on” state) and the return of membrane 504 to a position substantially in contact with membrane 506 (e.g., an “off” state) can be accommodated during a bending of the display system.

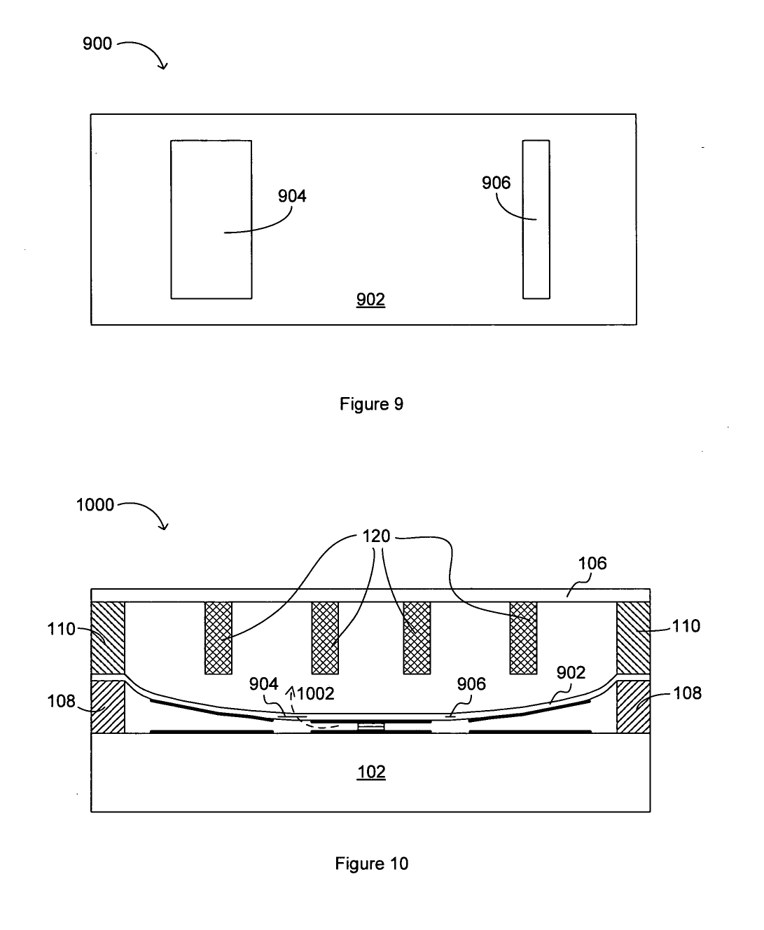

Because gasses within a cell, such as any of the cell embodiments described above, must be allowed to escape upon deflection of the flexible membrane (e.g., transition to the “on” state), “slots” may be included in the flexible membrane. Referring now to FIG. 9, a plan view of a flexible membrane of a cell of the micro electromechanical switches in accordance with an embodiment of the present invention is shown and indicated by the general reference character 900. Membrane 902 may correspond to membrane 104 or membrane 504, as discussed above, for example. In some embodiments, a plurality of “slots” or holes in membrane 902 can be formed. For example, the slots may be formed by using a conventional UV laser system. According to embodiments, slot 904 can be larger than slot 906 to facilitate a flow of gas or air from below membrane 902 upon deflection. Accordingly, the slots can be asymmetrical to advantageously induce the gas to flow in substantially a particular direction.

Referring now to FIG. 10, a sectional side view of an exemplary cell having the flexible membrane of FIG. 9 in an exemplary micro electromechanical switch in an “on” state in accordance with an embodiment of the present invention is shown and indicated by the general reference character 1000. Membrane 902 is shown as deflected toward membrane 102. Slots 904 and 906 are shown in membrane 902. Because slot 904 is larger than slot 906, the asymmetric nature of the slot arrangement can induce gas path 1002 to substantially flow as indicated.

In one aspect of embodiments of the present invention, a reactive gettering film can be incorporated into the structure of the switch array in a manner such that normal operation of the array is not substantially altered. In another aspect of embodiments of the present invention, the use of specific gettering materials can include active metal getters such as calcium and/or lithium. In another aspect of embodiments of the present invention, specific gettering materials that are substantially transparent can be used, such as deposited lithium aluminum hydride. According to embodiments of the present invention, such a metal gettering film 1004 can be added onto the inside face of membrane 106 or membrane 506 (e.g., within the gas volume of a sealed switch cell). In addition, such metal gettering may also be added to buffer structures 120 in some embodiments in order to increase the useful area of deposited gettering material such as is illustrated by the dashed lines 1006.

The active metal gettering material may be deposited by vacuum evaporation or vacuum sputtering, for example. Metal thicknesses of from a few tenths of microns to several tens of microns may be in an optimal range for some applications. However, thicknesses outside this range may be used as necessary or desirable for other applications. According to embodiments, such switch array structure alterations may be made substantially independent of any external connection and may not adversely effect any changes in the sequence of assembly or the subsequent reliability of the completed array, for example.

In operation, the gettering material can react with reactive gases which may leak into the cell structure or which were in the cell structure at the time of cell assembly. Since there are holes for gas passage in the flexible membrane (e.g., membrane 902, as discussed above), the entire volume of gas within the cell may be exposed to the gettering material. In this fashion, the cell may be substantially cleansed of impurities. In some switch cell operation, there is a distinct gas pumping action, so as the cell changes state, the gases may be positively, and with some turbulence, mixed and exchanged between the front of the cell, where switching takes place, and the back side of the cell, which functions as a gas ballast. This approach can ensure that the reactive gettering chemical will have good access to the entire gas volume.

One result of the incorporation of reactive gettering compounds into membrane 106/506 and/or buffer structure 120 is that the appearance of reactive gases in the cell structure, from gas molecules that have diffused into the back of membrane 106/506 and through the material of the membrane 106/506 (e.g., plastic material) may be reduced to essentially zero. This has an advantageous effect on the quality of the cell structure and can be expected to improve the switch contact reliability.

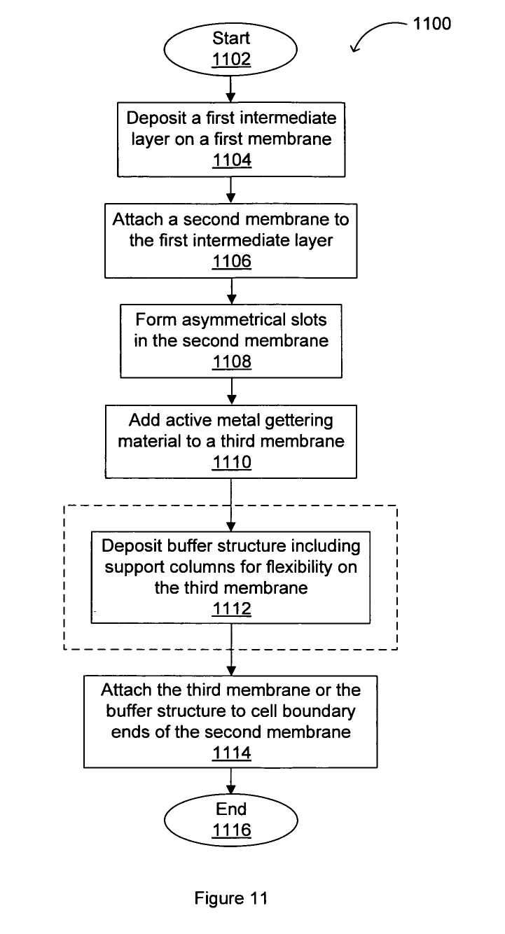

Referring now to FIG. 11, a possible flow diagram of a method of making an exemplary micro electro-mechanical switch in accordance with embodiments of the present invention is shown and indicated by the general reference character 1100. The flow can begin (1102) and a first intermediate layer can be deposited on a first membrane (1104). A second membrane may be attached to the first intermediate layer (1106). Asymmetrical slots can be formed in the second membrane, such as by the use of a conventional UV laser system (1108). An active metal gettering material can be added to a third membrane (1110). Optionally, a buffer structure with support “columns” can be added to the third membrane (1112). An exemplary embodiment showing such a buffer structure can be seen in FIGS. 1-4. If the buffer structures are not used, such an exemplary embodiment is shown in FIGS. 5-8. The third membrane or buffer structure may be attached to the cell boundary ends of the second membrane (1114) and the flow can complete (1116). In some embodiments, one or more of the manufacturing steps can include the use of roll-to-roll or printing type manufacturing technology, such as rotary printing presses and/or screen printing presses.

To manufacture the array, a roll of a relatively non-pliable foil of a desired width, such as 24 inches, and a couple of miles in length may be secured. The thickness of foil may range from 10 μm to 100 μm. Thicker foils are possible but the thickness must be matched to the intended application. The foil is preferably a polymer, polyimide, PET, PEN or other similar material. A first process step may be laser ablation to create via holes in the foil. The hole structures could be defined by photolithography methods and then etched but would be more labor intensive to complete. When the hole structures are established, the foil is run through a catalytic solution and placed into an electroless plating bath so that both surfaces and the via holes will be coated with metal to a thickness of about 0.5 μm to about 10 μm and preferably with about 2.0 μm to about 3.0 μm so long as the metal is capable of carrying the requisite current to energize the display. For membrane 102, the metal is preferably copper.

A resist pattern may then be printed on the copper-foil laminate using roll-to-roll printing equipment. The resist pattern is a lacquer (lacquer being defined as a term of art for an etchant resisting material most likely of simple organic or polymer origin) layer that is allowed to dry and then the laminate is placed into an etchant to remove copper that is not coated by the resist pattern. The pattern resolution may enable the printing of switch cells as small as about 20 μm by 20 μm although larger resolutions are usable for large display applications such as an outdoor sign. Thus, any open or expose copper will be etched by the etchant. The lacquer is a loaded ink that is printed such that it is thicker than the underlying copper with the minimal requirement being that the lacquer be pinhole free and resistant to the copper etchant.

The laminate may then be immersed in an organic solvent to remove the lacquer with the solvent being dependent on the type of lacquer and polymer foil used.

A second layer of lacquer may then be printed to define the contact area. The contacts are built up using the same electroless plating method because the coating rate is relatively fast and is well suited for roll-to-roll printing applications. It is possible to use vacuum sputter, electroplating, or evaporation to deposit the metal but the need to perform the coating in a rapid manner dictates that some plating method be preferred.

It is important that the lacquer thickness at this step is minimized if it is to be left on as an insulating layer over the copper. Because the lacquer acts as a dielectric layer, it will dissipate the electrostatic charge between the electrodes. To illustrate, air has a dielectric constant of 1.0 and lacquer has a dielectric constant of about 4.0. Thus for every micron of lacquer thickness, it has the same effect as if the electrodes were moved further apart by approximately 4 um. Thus, it is desirable to minimize the lacquer thickness so that it does not have more than a negligible impact on the electrostatic force but thick enough that the electrodes do not arc when they get close together. Fortunately, it is possible to maintain the lacquer thickness to between about 0.5 μm and 3.0 μm although thinner and thicker lacquers may be used in some applications. Other methods for forming the contact and printing an insulating layer of lacquer are possible. For example, screen printing or Gravuer printing techniques may be easily used.

Intermediate or spacer layer 108 is screen printed on top of membrane 102 rather than using photolithography techniques and comprises a polymer-based (plastic-like) ink. The height of spacer layer 108 is determined by the amount of ink that is applied to the membrane. As noted above, the spacer layer 108 may be perforated so that air can readily move in and out of the cell as the membrane displaces the air. In other embodiments, the spacer layer 108 is preferably contiguous so that air is not pumped into cells. The perimeter may be fairly wide so that it better can resist lateral stresses as the flexible membrane deflects and then returns to the “off” state. There is no requirement that spacer layer 108 be rigid. Indeed, it is acceptable that the layer be allowed to move laterally or to bend slightly relative to an axis perpendicular to the membranes.

The critical component in manufacturing a cell array is in careful selection of the flexible membrane material, its physical properties and the elastic modulus. Of these properties, the elastic modulus is the most critical. The elastic modulus must be as low as possible consistent with proper functioning and manufacturability. To illustrate, consider that copper has an elastic modulus on the order of 130×10⁹ Pascals (130 GPascals) while polymer materials such as PET have an elastic modulus on the order of 1 GPascal to about 5 GPascal. Clearly, there would be significant incompatibility if copper of significant thickness were used on the flexible membrane. Indeed, the elastic modulus of the flexible membrane may usefully range from about 1 MPascal to about 1 Gpascal. Accordingly, aluminum is the preferred metal for the row electrode because the elastic modulus of aluminum is about 70 GPascals. With a very thin aluminum layer its mechanical properties do not dominate. The flexible membrane is attached to the spacer layer by ultrasonic welding, adhesive bonding or similar known technique.

Due the thin foil-like nature of the flexible membrane, it is difficult to deposit metal and pattern the metal using photoresist without potentially melting the membrane. No claim is made that this process is impossible, but only that greater engineering of the process is required for success using conventional photoresist processes. Accordingly, one preferred method for depositing the aluminum is to pattern the membrane with a layer of oil to define the area of the membrane where metal is not desired. The membrane is then placed in a vacuum and the aluminum is sputtered onto the membrane. As the aluminum hits the oil, the oil is vaporized and creates a cloud through which prevents the metal from being deposited. The areas of the membrane without the oil will receive a thin coating of aluminum.

Other important characteristics in designing a cell are the spacing between membranes, the elastic modulus, and the size of the cell and the electrical properties of the display media. For example, in one embodiment, the thickness of the flexible membrane will range from about 2 μm to about 25 μm while the aluminum will be about 300 Angstroms to about 1,000 Angstroms thick with 400 to 500 Angstroms being a typical thickness. In another embodiment, the flexible membrane is a 6 μm thick PET foil that is spaced above the other membrane at a height of about 4 μm (that is the gap between the flexible foil and the non-pliable foil is 4 μm). The aluminum electrode has a thickness of 500 Angstroms and the cell size is a 1 mm by 1 mm rectangle.

With the present invention, it will be appreciated that it is possible to replace the silicon-on-glass thin film transistors (TFT) based backplanes with a matrix of MEM switches that are readily manufactured using inexpensive manufacturing equipment and printing process techniques. Further, it will be appreciated that the present invention enables the manufacture of scalable large optical displays on rigid or flexible plastic membranes at low cost that have an adequate and useful lifetime. Further still, the present invention enables the manufacture of optical displays that may be flexed or twisted into novel shapes while still maintaining the display properties.

There are many existing products, and potentially a large number of new products, that will benefit from an array of switches laid out in matrix pattern (sometimes uniform, sometimes not, depending on the application). With the present invention, it is possible to use the opened (or closed) switch to activate a variety of devices so needing such a switch.

With the present invention, the array switches may include one or more of the following attributes: (a) may be physically scaled depending on the application, (b) may switch either AC or DC voltages, (c) may switch either high or low voltage, (d) may switch high or low current, and (e) may be either a momentary or latched switch. The most common need for such an array today is for flat panel displays to replace the expensive backplane based on silicon transistors layered onto glass substrates.

It will further be appreciated that one or more of the elements depicted in the drawings/figures can also be implemented in a more separated or integrated manner, or even removed or rendered as inoperable in certain cases, as is useful in accordance with a particular application.

Although the invention has been described with respect to specific embodiments thereof, these embodiments are merely illustrative, and not restrictive of the invention. For example, further embodiments may include various display architectures, biometric sensors, pressure sensors, temperature sensors, light sensors, chemical sensors, X-ray and other electromagnetic sensors, amplifiers, gate arrays, other logic circuits, printers and memory circuits.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A display system comprising:
a first membrane and second membrane maintained in a spaced apart relationship by a first intermediate layer, said first intermediate layer defining a plurality of cells configured as a matrix;
a third membrane coupled to said first membrane;
within each cell, a column electrode printed on one side of said first membrane and a row electrode printed on an opposing side of said second membrane such than when a bias exists, said first membrane is deflected toward said second membrane;
a pair of contacts one of which is patterned on said first membrane in proximity to said column electrode and the other of which is patterned on said second membrane in proximity to said row electrode, said pair of contacts completing an electrical circuit when said first membrane is deflected toward said second layer; and
a display media that is biased to an ON state when said pair of contacts complete said electrical circuit.

2. The display system of claim 1, further comprising a second intermediate layer between said first and third membranes.

3. The display system of claim 2, wherein said second intermediate layer comprises a plurality of buffer structures configured to substantially maintain said spaced apart relationship when said display media is bent.

4. The display system of claim 3, wherein said second intermediate layer is substantially aligned with said first intermediate layer.

5. The display system of claim 1, wherein said first membrane includes two slots configured to allow a gas to flow through said first membrane when said first membrane is deflected toward said second membrane.

6. The display system of claim 5, wherein a first of said two slots is larger than a second of said two slots.

7. The display system of claim 1, wherein said third membrane includes a layer of gettering material deposited thereon.

8. The display system of claim 7, wherein said gettering material includes active metal gettering material.

9. The display system of claim 1, wherein said display media comprises an electrophoretic material that changes from one state to another state in the presence of an electric field induced by the bias applied across said row and column electrode.

10. The display system of claim 3, wherein said third membrane and said plurality of buffer structures include a layer of gettering material deposited thereon.

11. The display system of claim 10, wherein said first membrane is selected from the group of polymers, polyimides, polyethylene terephthalate (PET), polyethylene naphthalate (PEN)) polymer alloys or elastic materials.

12. A micro electromechanical (MEM) switch, comprising:
a first membrane and second membrane maintained in a first spaced apart relationship by a first intermediate layer, said first membrane being configured to be deflected toward said second membrane in response to a bias; and
a third membrane maintained in a second spaced apart relationship from said first membrane by a second intermediate layer, said second intermediate layer being configured to maintain said first spaced apart relationship in response to a bending of said MEM switch.

13. The MEM switch of claim 12, wherein said second intermediate layer comprises a plurality of buffer structures.

14. The MEM switch of claim 12, wherein said second intermediate layer is substantially aligned with said first intermediate layer.

15. The MEM switch of claim 12, wherein said first membrane includes two slots configured to allow a gas to flow through said first membrane when said first membrane is deflected toward said second membrane.

16. The MEM switch of claim 15, wherein a first of said two slots is larger than a second of said two slots.

17. The MEM switch of claim 12, wherein said third membrane includes a layer of gettering material deposited thereon.

18. The MEM switch of claim 17, wherein said gettering material includes active metal gettering material.

19. A method of making a micro electromechanical (MEM) switch, comprising the steps of:
(a) depositing a first intermediate layer on a first membrane;
(b) attaching a second membrane to said first intermediate layer;
(c) adding a gettering material to a third membrane; and
(d) attaching said third membrane to said second membrane.

20. The method of claim 19, further comprising the step of forming asymmetrical slots in said second membrane.

21. The method of claim 20, wherein the step of forming asymmetrical slots includes using a UV laser system.

22. The method of claim 20, further comprising the step of depositing a second intermediate layer on said third membrane.

23. The method of claim 22, wherein said second intermediate layer includes a plurality of buffer structures.

24. The method of claim 19, wherein at least one of the steps includes using roll-to-roll or printing type manufacturing technology.

25. A switch array element, comprising a reactive gettering film deposited on a component layer of said switch array element, wherein a normal operation of said switch array element is not substantially altered.

26. A MEM switch structure, comprising a plurality of layers, wherein at least one of said plurality of layers is arranged in a plurality of columns configured to substantially maintain a spacing between at least two other layers of said plurality of layers upon a bending of said MEM switch structure.
